(19) United States
(12) Patent Application Publication
(10) Pub. No.: US 2010/0332222 A1
(43) Pub. Date: Dec. 30, 2010

(54) INTELLIGENT CLASSIFICATION METHOD OF VOCAL SIGNAL

(75) Inventors: MINGSIAN R. BAI, Hsinchu (TW); MENG-CHUN CHEN, Hsinchu (TW)

Correspondence Address: ROSENBERG, KLEIN & LEE, 3458 ELLICOTT CENTER DRIVE-SUITE 101, ELLICOTT CITY, MD, 21043, US

(73) Assignee: NATIONAL CHIAO TUNG UNIVERSITY, Hsinchu (TW)

(21) Appl. No.: 12/878,130

(22) Filed: Sep. 9, 2010

Related U.S. Application Data
(63) Continuation-in-part of application No. 11/592,185, filed on Nov. 3, 2006.

(30) Foreign Application Priority Data
Sep. 29, 2006 (TW) 095136283

(51) Int. Cl. G10L 11/06

(52) U.S. Cl. 704/214; 704/E11.001

(57) ABSTRACT

An intelligent classification method is proposed. The method extracts vocal features from the temporal domain, spectral domain and statistical features for measuring the vocal signal. The measured result is grouped by comparing with the trained data with single voiced source, and then different voices can be separated from the vocal signal to be classified. The vocal features are evaluated from temporal domain and spectral domain and the statistical features, and the method can improve the accuracy of the voice classification.

The present application is a continuation in part of U.S. application Ser. No. 11/592,185 titled “INTELLIGENT CLASSIFICATION SYSTEM OF SOUND SIGNALS AND METHOD THEREOF”, filed Nov. 3, 2006 and presently pending.

### BACKGROUND OF THE INVENTION

1. Field of the Invention

The present invention generally relates to a classification method of a vocal signal, and more particularly relates to an intelligent classification method of a vocal signal and the method evaluates temporal features, spectral features and statistical features of the vocal signal to improve the accuracy of the vocal classification.

2. Description of the Prior Art

Digital music is popular in recent years due to the Internet. Many people have downloaded large number of music from the Internet and store them in the computer or the MP3 player randomly. Up to now, the categorization for music is performed manually. But when the quantity of music accumulated gradually, the work of classifying them requires much time and labor. In particular, the work needs a skilled person to listen to the music files and to classify them.

Currently, in the audio feature extraction, the Linear Predictive Coding, Mel-scale Frequency Cepstral Coefficients, and so on to extract the features in the frequency domain. The frequency's feature cannot fully represent the music.

Additionally, in the data classification, Artificial Neural Networks, Nearest Neighbor Rule and Hidden Markov Models are used for image recognition and the result is very effective.

A mandarin audio dialing device with the structure of Fuzzy Neural Networks is disclosed in Taiwan's patent NO. 140662. The Fuzzy Neural Network recognizes the accent of the human speaking in the car to dial the phone number without button touching. The device uses Linear Predictive Coding to extract features from audio signals, which is unable to present all the properties of the audio signal, especially, when the audio signal mixes with background noise, like the music from car radio, the errors are produced often.

Another classification of audio signals is disclosed in U.S. Pat. No. 5,712,953. A spectrum module in a classification device receives a digitized audio signal from a source and generates a representation of the power distribution of the audio signal with respect to the frequency and the time. Its applying area is limited and not suitable for the whole music and songs.

### SUMMARY OF THE INVENTION

In view of the above problems associated with the related art, it is an object of the present invention to provide an intelligent classification system of sound signals. The invention extracts some values of songs from a spectral domain, a temporal domain and a statistical value, which present the features of songs thoroughly.

It is another object of the present invention to provide a system and method for identification of singers or instruments by using nearest neighbor rule, artificial neural network, fuzzy neural network or hidden Markov model. Such system identifies the sound of singers and instruments, then the method automatically classifies them into the singers' name or categories.

It is a further object of the present invention to provide a system and method for separating the component of mixed signals by using a independent component analysis, which can separate the singer's voice from the album CD to make Karaoke-like media, on the other view, the invention can reduce the environmental noises when recording the audio.

Accordingly, one embodiment of the present invention is to provide an intelligent classification system, which includes: a feature extraction unit receiving a plurality of audio signals, and extracting a plurality of features from the audio signal by using a plurality of descriptors; a data preprocessing unit normalizing the features and generating a plurality of classification information; a classification unit grouping the audio signals to various kind of music according to the classification information.

In addition, an intelligent classification method includes: receiving a first audio signal and extracting a first group of feature variables by using an independent component analysis unit; normalizing the first group of feature variables and generating a plurality of classification items; receiving a second audio signal and extracting a second group of feature variables; normalizing the second group of feature variables and generating a plurality of classification information; and using artificial intelligent algorithms to classify the second audio signal into the classification items, and storing the second audio signal into at least one memory.

Other advantages of the present invention will become apparent from the following description taken in conjunction with the accompanying drawings wherein are set forth, by way of illustration and example, certain embodiments of the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a schematic diagram illustrating an intelligent system for the classification of sound signals in accordance with one embodiment of the present invention;

FIG. 2 is a schematic diagram illustrating a multiplayer feedforward network in the classification unit in accordance with one embodiment of the present invention;

FIG. 3 is a schematic diagram of another embodiment illustrating a Fuzzy Neural Network in the classification unit in accordance with the present invention;

FIG. 4 is a flow chart illustrating the method of Nearest Neighbor Rule in accordance with one embodiment of the present invention; and

FIG. 5 is a flow chart illustrating the method of Hidden Markov Model in accordance with one embodiment of the present invention; and

FIG. 6 is a computer flow chart for an extraction module extracting parameters of an audio signal.

### DESCRIPTION OF THE PREFERRED EMBODIMENT

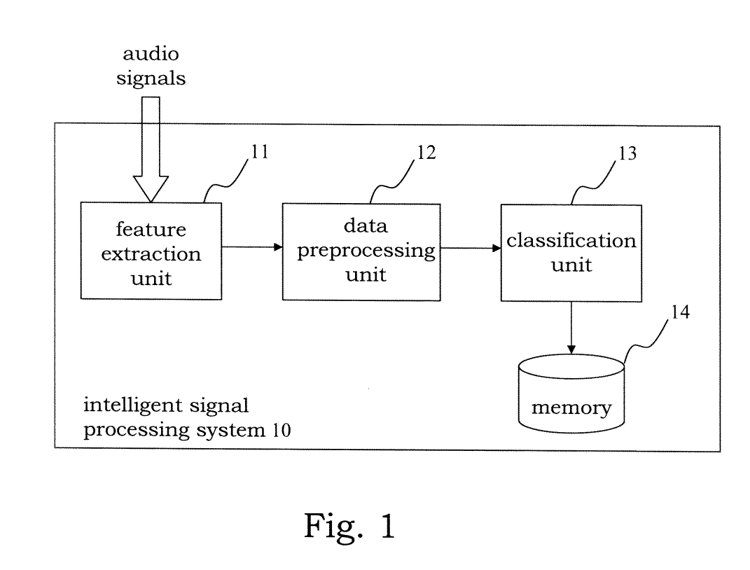

FIG. 1 is a schematic diagram illustrating an intelligent system for the classification of sound signals in accordance with one embodiment of the present invention. A feature extraction unit 11 receives audio signals and extracts a plurality of features from the audio signals by using a plurality of descriptors. The feature extraction unit 11 extracts the feature from a spectral domain, a temporal domain and a statistical value. In the spectral domain, the descriptors includes: audio spectrum centroid, audio spectrum flatness, audio spectrum envelope, audio spectrum spread, harmonic spectrum centroid, harmonic spectrum deviation, harmonic spectrum variation, harmonic spectrum spread, spectrum centroid, linear predictive coding, Mel-scale frequency Cepstral coefficients, loudness, pitch, and autocorrelation. In the temporal domain, the descriptors include: log attack time, temporal centroid and zero-crossing rate. In the statistical value, the descriptors include skewness and Kurtosis.

Furthermore, the features from the spectral domain are spectral features, the features from the temporal domain are temporal features, and the features from the statistical value are statistical features. Spectral features are descriptors computed from Short Time Fourier Transform of the signal, such as Linear Predictive Coding, Mel-scale Frequency Cepstral Coefficients, and so forth. Temporal features are descriptors computed from the waveform of the signal, such as Zero-crossing Rate, Temporal Centroid and Log Attack Time. Statistical features are descriptors computed according to the statistical method, such as Skewness and Kurtosis.

A voice source has its own features. A vocal signal is a combination of different voice sources, which can be express as the superposition of voice sources that means the vocal signal is the combination of the features with its corresponding weight. The vocal signal can be expressed by the combination of different voice features as the following equation.

$$S = {\sum }_{n = 1}^{N} {w}_{n} {f}_{n} , \qquad ( 1 )$$

where S is a vocal signal, {fₙ} are features of the vocal signal, {wₙ} are weighting coefficients and N is the number of vocal signal. The vocal signal can be also expressed as a combination of different voice sources as the following equation.

$$S = {\sum }_{i = 1}^{M} {x}_{i} {s}_{i} , \qquad ( 2 )$$

where {sᵢ} expresses different voice sources, {xᵢ} are the feature weighting coefficients of voice sources and M is the number of voice source. Each voice source can be expressed as the following equation.

$${s}_{i} = {\sum }_{n = 1}^{N} {v}_{n}^{i} {f}_{n} , \qquad ( 3 )$$

where {vₙⁱ} are the weighting coefficients of the voice source. Take (3) into (2) and the weighting function can be expressed as the following equation.

$${w}_{n} = {\sum }_{i}^{M} {v}_{n}^{i} {x}_{i} \qquad ( 4 )$$

{wₙ} can be obtained when the vocal signal is detected once the features are defined, and {vₙⁱ} can also be obtained from each of voice sources. As a result, the optimized {xᵢ} can be obtained. The method of optimizing the set of includes

(step 1) to set an initial {xᵢ}₀

(step 2) to calculate one set of {wₙ}₀ using the initial {xᵢ}₀

(step 3) to test whether Δ({wₙ},{wₙ}₀)<Δwₜₕ or not

(step 4) to determine {xᵢ} whether the Δ({wₙ},{wₙ}₀) converges into Δwₜₕ or not

(step 5) to give a new set of {xᵢ}₀ when Δ({wₙ},{wₙ}₀) do not converges into the threshold value Δwₜₕ and to repeat the process until the {xᵢ}₀ is converged.

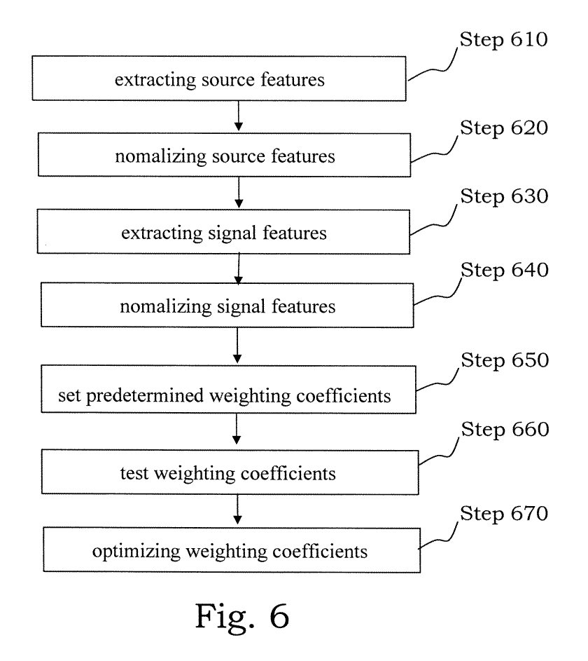

In conventional skill, the features are defined by frequency and its corresponding amplitude. In this invention, differing from the conventional arts, the features are defined in temporal domain, spectral domain and statistical features. The features can improve the classification of voice source. Refer to FIG. 6, the classification method in this invention includes:

(step 610) The feature extraction unit 11 is used to find the features of different voice sources

(step 620) The data preprocessing unit 12 is used to normalize the features of each voice source to obtain the corresponding weighting coefficients for each voice source on each feature.

(step 630) The feature extraction unit 11 is used to find the features of a vocal signal.

(step 640) The data preprocessing unit 12 is used to normalize the features of the vocal signal to obtain the corresponding weighting coefficients for vocal signal on each feature.

(step 650) The classification unit 13 is used to set predetermined weighting coefficients for the vocal signal on each voice source and to calculate test weighting coefficients of the vocal signal on each feature by multiplying the predetermined weighting coefficients and the test weighting coefficients of each voice source on each feature.

(step 660) The classification unit 13 is used to test whether the test weighting coefficients converges to the weighting coefficients of the vocal signal on each feature or not.

(step 670) The classification unit 13 is used to determine the predetermined weighting coefficients is optimized once the different between the test weighting coefficients and the weighting coefficients of the vocal signal on each feature is smaller than a threshold value. If the test weighting coefficients do not converge to a threshold value, the predetermined weighting coefficients should be modified and retest until the optimized weighting coefficients are found.

The above steps can be implemented by a software application, such as a computer readable medium or a machine readable medium. The software application includes at least three modules: a feature extraction module, a normalization module and a classification module.

The feature extraction module can extracts the features from a voice. In this embodiment, the feature extraction module extracts features from the vocal signal and each voice source. The feature extraction module is carried out by the feature extraction unit 11.

The normalization module can efficiently organize the data and improves data consistency. In this embodiment, these features are normalized into the interval [−1, 1]. The normalization module is carried by the preprocessing unit 12.

The classification module can de-mix the voice into different voice sources with a set of weighting coefficients by comparing the vocal signal and trained data. In this embodiment, the comparison methods of the classification module are enumerated, such as nearest neighbor rule (NNR), artificial neural network (ANN), fuzzy neural network (FNN) or hidden Markov model HMM. The classification module is carried by the classification unit 13.

The preprocessing unit 12 is connected to the feature extraction unit 11 to normalize the features obtained by the feature extraction unit 11. The classification unit 13 is connected to the preprocessing unit 12 to obtain the optimized weighting coefficients of voice sources by comparing the voice features on vocal signal and the training data.

There are 19 features are used in the embodiments according to the spirit of this invention. Three features are in temporal domain, fourteen features are in spectral domain and two features are the statistical features. The feature definitions are list as follows.

### In Temporal Domain

Log Attack Time (LAT), Temporal Centroid (TC) and zero-crossing rate are defined.

LAT=log₁₀(tₘₐₓ−tₘᵢₙ) (5),

where tₘₐₓ is the time of maximum amplitude of the vocal signal, and tₘᵢₙ is the time of silence. Basically, the LAT is the logarithmic time of the vocal signal change rate. LAT is used to measure the time from silence to maximum amplitude. Therefore the sharpness of a vocal signal can be characterized by LAT.

$$TC = \frac{{\sum }_{n = 1}^{length ( SE )} ( n / SR ) SE ( n )}{{\sum }_{n = 1}^{length ( SE )} SE ( n )} \qquad ( 6 )$$

where SR is the sampling rate, SE(n) is the vocal signal voice envelope at time instance n, and

$$\frac{SE ( n )}{\sum SE ( n )}$$

is the signal distribution in time. TC is used to measure the energy concentration of the vocal signal in time. Therefore the time concentration of vocal signal can be characterized by TC.

Zero-crossing rate is the vocal signal envelope reaches zero in unit time that is the frequency of the amplitude of the vocal signal reaching zero.

### In Spectral Domain

Audio spectrum envelope (ASE), audio spectrum centroid (ASC), audio spectrum flatness (ASF), audio spectrum spread (ASS), harmonic spectrum centroid (HSC), harmonic spectrum deviation (HSD), harmonic spectrum variation (HSV), harmonic spectrum spread (HSS), spectrum centroid (SC), linear predictive coding (LPC), Mel-scale frequency Cepstral coefficients (MFCC), loudness, pitch and autocorrelation are defined. The vocal signal can be transformed into frequency domain by FFT transformation, and then the power spectrum can obtained, shown as P(ω), where ω is the angular frequency. The power distribution can be expressed as

$$ASE ≡ \frac{{\vert A ( ω ) \vert}^{2}}{{I}_{w} \cdot NFFT} = P ( ω ) \frac{P ( ω )}{\sum P ( ω )} . \qquad ( 7 )$$

where A(ω) is magnitude of a component in frequency range of 62.5 Hz to 8 kHz, l_{w} is the window length and NFFT is the FFT (Fast Fourier Transformation) size.

$$\begin{matrix}ASC ≡ \frac{\sum {log}_{2} ( \frac{f ( ω )}{1000} ) P ( ω )}{\sum P ( ω )} & ( 8 ) \\ ASF ≡ \frac{\sqrt[{ω}_{h} - {ω}_{l} + 1]{{\prod }_{{ω}_{l}}^{{ω}_{h}} P ( ω )}}{{( {ω}_{h} - {ω}_{l} + 1 )}^{- 1} {\sum }_{{ω}_{l}}^{{ω}_{h}} P ( ω )} & ( 9 )\end{matrix}$$

where f(ω) is frequency and ωₗ and ωₕ are respectively high and low edges of the band.

$$\begin{matrix}ASS ≡ \sqrt{\frac{\sum {( {log}_{2} ( \frac{f ( ω )}{1000} ) - ASC )}^{2} P ( ω )}{\sum P ( ω ) )}} & ( 10 ) \\ HSC = \frac{{\sum }_{i = 1}^{{N}_{f}} {\sum }_{h = 1}^{{N}_{h}} {f}_{i} ( h ) {A}_{i} ( h )}{{N}_{f} \cdot {\sum }_{i = 1}^{{N}_{f}} {A}_{i} ( h )} & ( 11 )\end{matrix}$$

where fᵢ(h) is the frequency of the h-th harmonic (=ωₕⁱ=2πfᵢ(h)), Aᵢ(h) is the magnitude of the h-th harmonic, N_{f} is the number of frames and i is the i-th frame index.

$$HSD ≡ \frac{{\sum }_{i = 1}^{{N}_{f}} {\sum }_{h = 1}^{{N}_{h}} \vert {log}_{10} [ {A}_{i} ( h ) ] - {log}_{10} [ {SE}_{i} ( h ) ] \vert}{{N}_{f} \cdot {\sum }_{h = 1}^{{N}_{h}} {log}_{10} [ {A}_{i} ( h ) ]} \\ where \\ {SE}_{i} ( h ) ≡ \{ \begin{matrix}\frac{{A}_{i} ( h ) + {A}_{i} ( h + 1 )}{2} , … h = 1 \\ \frac{{\sum }_{l = - 1}^{l} {A}_{i} ( h + 1 )}{3} , h ∈ [ 2 , {N}_{h} - 1 ] \\ \frac{{A}_{i} ( h ) + {A}_{i} ( h + 1 )}{2} , … h = {N}_{h}\end{matrix} , \qquad ( 12 )$$

and SEᵢ(h) is the harmonic spectral envelope.

$$\begin{matrix}HSV ≡ \frac{{\sum }_{i = 2}^{{N}_{f}} ( 1 - \frac{{\sum }_{h = 1}^{{N}_{h}} {A}_{i - 1} ( h ) {A}_{i} ( h )}{\sqrt{{\sum }_{h = 1}^{{N}_{h}} {A}_{i - 1}^{2} ( h )} \sqrt{{\sum }_{h = 1}^{{N}_{h}} {A}_{i}^{2} ( h )}} )}{{N}_{f} - 1} & ( 13 ) \\ HSS ≡ \frac{{\sum }_{i = 2}^{{N}_{f}} \sqrt{\frac{{\sum }_{h = 1}^{{N}_{h}} {{A}_{i} ( h ) [ {f}_{i} ( h ) - IHSC ( i ) ]}^{2}}{{\sum }_{h = 1}^{{N}_{h}} {A}_{i}^{2} ( h )}}}{{N}_{f} \cdot IHSC ( i )} \\ where \\ IHSC ( i ) = \frac{{\sum }_{h = 1}^{{N}_{f}} {f}_{i} ( h ) {A}_{i} ( h )}{{\sum }_{h = 1}^{{N}_{f}} {A}_{i} ( h )} . & ( 14 ) \\ SC ≡ \frac{{\sum }_{i = 1}^{{N}_{f}} \frac{{\sum }_{ω = 1}^{length ( S )} {f}_{i} ( ω ) {P}_{i} ( ω )}{{\sum }_{ω = 1}^{length ( S )} {P}_{i} ( ω )}}{{N}_{f}} & ( 15 )\end{matrix}$$

LPC, MFCC and other descriptors can be found in the other approaches, and these approaches can be used as the features of the vocal signal to improve the classification method. The number of features will be the dimensions of the {wₙ}, {xᵢ} and {vₙⁱ} that causes massive calculation to reduce the performance. In some cases, the voice sources are limited, and some features can be reduced for simplify the calculation for improving the performance.

### Statistical Features

Skewness (SK) and Kurtosis (K) are defined.

$$SK ≡ \frac{E \{ {( x - μ )}^{3} \}}{{σ}^{3}} \qquad ( 16 )$$

where E{•} is the expectation, x is a random variable and μ and σ are respectively mean and standard deviation. The Skewness is used to measure the asymmetry of the vocal signal.

$$K ≡ \frac{E \{ {( x - μ )}^{4} \}}{{σ}^{4}} \qquad ( 17 )$$

The Kurtosis is used to measure the outlier-proneness of the vocal signal.

Accordingly, the intelligent signal processing system 10 may automatically classify the received mixed signals into many groups, and store them in the memory 14. For example, the system 10 would classify the music downloaded from the Internet according to singers or instruments, wherein the music may be the mixed signal of a vocal signal and instruments' sound signal, the mixed signal of human's sound signal and instruments' sound signal, or the mixed signal of human's sound signal and the instrument's sound signal.

In addition, before the intelligent signal processing system 10 an independent component analysis (ICA) unit (not shown) receives an audio signal and separates it to a plurality of sound components. In the field of audio preprocessing, we may remove the voice from the songs by using independent component analysis. Besides, independent component analysis can help the system lower the noise while we record sound in a nosy environment.

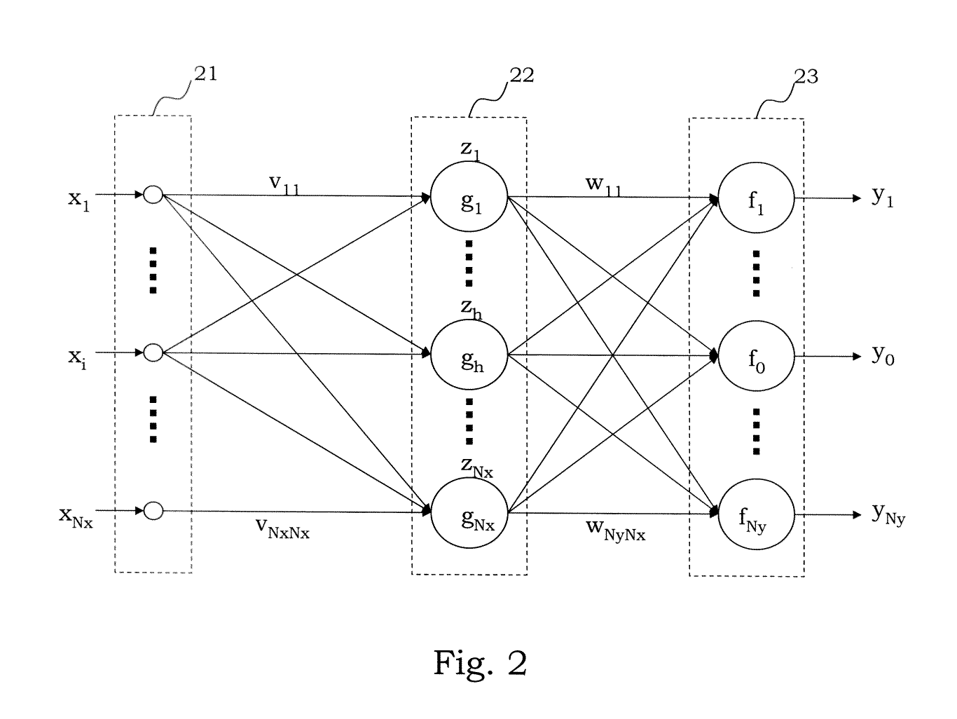

FIG. 2 is a schematic diagram illustrating a multiplayer feedforward network in the classification unit 13 in accordance with one embodiment of the present invention. The multiplayer feedforward network is used in the artificial neural network, wherein the first layer is an input layer 21, the second layer is a hidden layer 22, and the third layer is an output layer 23. The input values x₁ . . . xᵢ . . . and x_{Nx} are normalized and outputted from the data preprocessing unit 12. The input values are weighted by multiplexing the vales v₁₁ . . . and v_{NxNx} and calculated with functions of g₁ . . . gₕ . . . and g_{Nx} respectively, at the end the output values z₁ . . . zₕ . . . and z_{Nx} are obtained. Again, the output values z₁ . . . zₕ . . . and z_{Nx} are weighted by multiplexing the vales w₁₁ . . . and w_{NxNx} and calculated with functions of f₁ . . . f₀ . . . and f_{Ny} respectively to generate the output values y₁ . . . y₀ . . . and y_{Ny}, wherein the weighted values are adjusted with the difference of output values and the targets by using the back-propagation algorithm. The errors between actual outputs and the targets are propagated back to the network, and cause the nodes of the hidden layer 22 and output layer 23 to adjust their weightings. The modification of the weightings is done according to the gradient descent method.

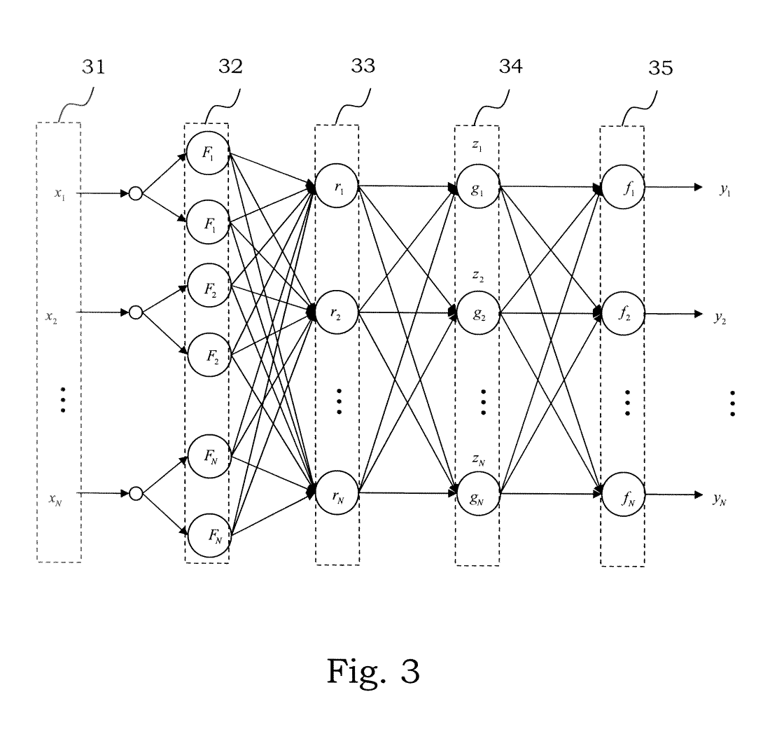

FIG. 3 is a schematic diagram of another embodiment illustrating a Fuzzy Neural Network in the classification unit in accordance with the present invention. The Fuzzy Neural Network includes an input layer 31, a membership layer 32, a rule layer 33, a hidden layer 34, and an output layer 35. The input values (x₁, x₂ . . . x_{N}) are the features of signals from data preprocessing unit 12. Next, the Gaussian function is used in the membership layer 32 for incorporating the fuzzy logics with the neural networks. And the membership layer 32 is normalized to transfer to the rule layer 33, and multiplexed with weighted values respectively to become the hidden layer 34. Lastly, the hidden layer 34 is weighted with different values to generate the output layer 35. The weighted values are adjusted with the difference of output values and the targets by using the back-propagation algorithm until the output values are proximate to the targets.

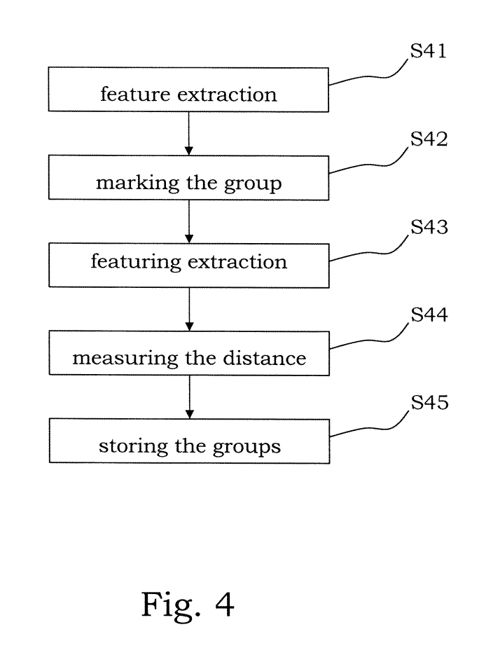

FIG. 4 is a flow chart illustrating the method of Nearest Neighbor Rule in accordance with one embodiment of the present invention. In step S41 feature extraction, an independent component analysis extracts some feature variables from a training signal. In step S42 marking group, feature variables are normalized and a plurality of classification items are generated. In step S43 feature extraction, the system receives a signal of audio and extracts some feature variables; in step S44, measuring the distance according to Euclidean distance by using the nearest neighbor rule; and in step S45, storing the groups into a memory.

The normalization process comes after feature extraction. It eliminates redundancy, organizes data efficiently, reduces the potential for anomalies during the data operations and improves the data consistency. The steps of normalization include: dividing the features into several parts according to the extraction method; finding the minimum and maximum in each data set; and resealing each data set so that the maximum of each data is 1 and the minimum of each data is −1.

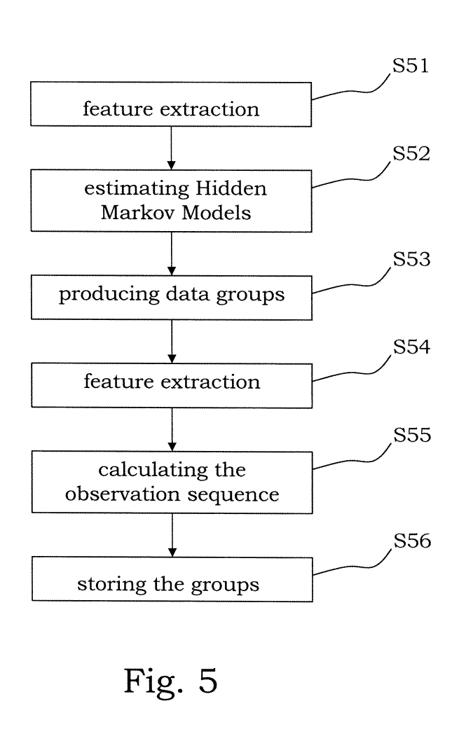

FIG. 5 is a flow chart illustrating the method of Hidden Markov Model in accordance with one embodiment of the present invention. The Hidden Markov Model is a random process, called observation sequence. In step S51 feature extraction, an independent component analysis extracts some features from a training signal. In step S52, estimating Hidden Markov Models for each feature by using Baum-Welch method, and producing data groups for those models in Step S53. In step S54, extracting a group of features from audio signals to form a new observation sequence. In step S55, calculating the observation sequence by using Viterbi algorithm. In step S56, storing the groups into a memory. For each unknown category to be recognized, the measurement of the observation sequence via a feature analysis of the signal corresponding to the category must be carried out; followed by the calculation of model likelihood for all possible models; followed by the selection of the category whose model likelihood is the highest. The probability computation is performed using the Viterbi algorithm.

Table 1 shows the experimental results of the singer identification in accordance with the present invention. The three categories are three singers (Taiwanese): Wu, Du, and Lin. Four classification techniques include NNR, ANN, FNN, and HMM. For each singer, training signals use seven songs and testing signal uses the other one that is different from those used for training (external test). The dimension of the feature space is 75. The number of the training data is 3500 and the number of testing data is 100.

TABLE 1

| Classification Method | Successful Detection Rate |
|---|---|
| Near Neighbor Rate | 64% |
| Artificial Neural Network | 90% |
| Fuzzy Neural Network | 94% |
| Hidden Markov Model | 89% |

Table 2 shows the experimental results of instrument identification in accordance with present invention. It reveals that the four classification techniques are all effective.

TABLE 2

| Classification Method | Successful Detection Rate |
|---|---|
| Near Neighbor Rate | 100% |
| Artificial Neural Network | 98% |
| Fuzzy Neural Network | 99% |
| Hidden Markov Model | 100% |

Overall, the performance of the FNN is the best, while the performance of the ANN and the HMM are satisfactory.

While several sources are mixed artificially in a PC, ICA may separate perfectly without knowing anything about the different sound sources. For example, two instruments (piano and violin) are chosen to perform the same music or different music, and then mix them in a PC. We found the ICA could successfully separate these blindly mixed signals. In another condition, several microphones record sounds in a noisy environment. With the help of ICA, the unwanted noise could be lowered but could not be lowered.

In the invention, ICA is used to separate the blind sources, to remove the voice, and to reduce the noise. We could remove the voice from songs, and reduce the noise while recording in a noisy environment by using ICA, which could be applied to a karaoke machine, a recorder, and etc.

Accordingly, the present invention receives a training audio signal, extracts a group of feature variables, normalizes feature variables and generates a plurality of classification items for training the system; next, the system receives a test audio signal, extracts feature variables, normalizes feature variables and generates a plurality of classification information; lastly, the system uses artificial intelligent calculation to classify a test audio signal into classification items, and stores the test audio signal into the memory.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. An intelligent classification method of sound signals comprising:
Extracting temporal features from a temporal domain, spectral features from a frequency domain and statistical features of a vocal signal;
Normalizing the temporal features, the spectral features and the statistical features to obtain the weighting coefficients of the vocal signal on each feature;
Extracting temporal features from a temporal domain, spectral features from a frequency domain and statistical features of voice sources;
Normalizing the temporal features, the spectral features and the statistical features to obtain the weighting coefficients of each voice source on each feature;
Setting predetermined weighting coefficients of the vocal signal on each voice source;
Multiplying the predetermined weighting coefficients and the source weighting coefficients to obtain a test weighting coefficients of the vocal signal on each feature;
Testing whether the test weighting coefficients converges into the weighting coefficients of the vocal signal on each feature;
Determining an optimized weighting coefficients of the vocal signal on each feature when the test weighting coefficients are converged;
Modifying the predetermined weighting coefficients and retesting the test weighting coefficients until the optimized weighting coefficients is obtained.

2. The intelligent classification method according to the claim 1, wherein the temporal features comprises a log attack time, and the log attack time is to measure the time from silence to the maximum amplitude.

3. The intelligent classification method according to the claim 1, wherein the temporal features comprises a temporal centroid, and the temporal centroid is measure the energy concentration in time.

4. The intelligent classification method according to the claim 1, wherein the temporal features comprises a zero-crossing rate, and the zero-crossing rate is to measure the frequency of the vocal signal reaching zero amplitude.

5. The intelligent classification method according to the claim 1, wherein the spectral features comprise an audio spectrum centroid (ASC), an audio spectrum flatness (ASF), an audio spectrum envelope (ASE), an audio spectrum spread (ASS), a harmonic spectrum centroid (HSC), a harmonic spectrum deviation (HSD), a harmonic spectrum variation (HSV), a harmonic spectrum spread (HSS), spectrum centroid (SC), linear predictive coding (LPC), a Mel-scale frequency Cepstral coefficients (MFCC), loudness, pitch and autocorrelation.

6. The intelligent classification method according to the claim 1, wherein the statistical features comprise Skewness to measure the asymmetry of the vocal signal.

7. The intelligent classification method according to the claim 1, wherein the statistical features comprise Kurtosis (K) to measure the outlier-proneness of the vocal signal.

8. The intelligent classification method according to the claim 1, wherein the step of testing is implemented by a nearest neighbor rule (NNR), an artificial neural network (ANN), a fuzzy neural network (FNN) or a hidden Markov model (HMM).

9. A computer readable medium implementing an intelligent classification method of claim 1, and the computer readable medium comprising:
a feature extraction module for extracting temporal features from a temporal domain, spectral features from a frequency domain and statistical features of a vocal signal and voice sources;
a normalization module for normalizing the extracted features into [−1, 1] to obtain the weighting coefficients of the vocal signal and the voice sources; and
a classification module for testing and determining a optimized coefficients of the vocal signal.
